(19) United States
(12) Patent Application Publication
(10) Pub. No.: US 2003/0103533 A1
(43) Pub. Date: Jun. 5, 2003

(54) Parallel signal dividing and signal processing in multiplex devices with a high ordinal number

(76) Inventors: Wolfgang Hilgers, Mering (DE); Walter Proebster, M?uuml;nchen (DE)

Correspondence Address: BELL, BOYD & LLOYD, LLC, P. O. BOX 1135, CHICAGO, IL, 60690-1135, US

(21) Appl. No.: 10/203,144

(22) PCT Filed: Jan. 23, 2001
(86) PCT No.: PCT/DE01/00262

(30) Foreign Application Priority Data
Feb. 4, 2000 (DE) 100 04 993.1

(51) Int. Cl. H04J 3/02

(52) U.S. Cl. 370/539

(57) ABSTRACT

The invention relates to a device and a method for parallel signal dividing and signal processing in multiplex devices with a high ordinal number. The advantage of the inventive nth level multiplex device lies in the fact that n transmission-end signals are divided cyclically among n/m mth level multiplex devices at a second multiplex device level, said second multiplex device level enabling the n/m mth level multiplex devices to be processed parallel to n/m partial signals and these n/m partial signals to be cyclically and sequentially processed into one signal by a parallel serial converter at a first multiplex device level. The resulting signal already has the arrangement of channels and bytes prescribed by the SDH format. The sorting process at the first multiplex device level, which is demanding in terms of memory, is therefore no longer necessary.

In TDM networks, transmission channels are utilized in synchronous time division multiplex by assignment of time segments for producing data connections. In synchronous time division multiplex, the identification of a channel is realized by assigning a time window to the channel and defining the relative temporal position of the time window, with respect to a synchronization frame.

Multiplex apparatuses serve for producing data connections such that a plurality of signals with a low transmission speed can be combined to form a signal with a higher transmission speed.

Conventional multiplex devices with a high ordinal number and high bit rates to be transmitted in TDM networks require large realization complexes. In particular, the matching/adaptation of the transmission-end signals to a signal with a predetermined SDH protocol architecture requires a large functional scope. Hitherto, the signal formation of a signal in the SDH format has been achieved by means of only one multiplex apparatus and thus by means of an integrated circuit, e.g. a CMOS module of high complexity.

One disadvantage of the previous multiplex apparatuses has been the conversion of the transmission-end signals to form a signal in the SDH format with only one complex module. Since this signal formation has required re-sorting of the channels of the multiplexed signals, the multiplex apparatuses that have been customary hitherto have required a large buffer memory. Therefore, large multiplex stages and signals with high bit transmission rates require a high outlay on memory and high expenditure of time for the sorting of the channels and bit rates. Moreover, this operation results in a non-negligible power loss at the multiplex apparatus.

The object of the present invention is to provide a modular arrangement for a multiplex apparatus which processes n signals into one signal and, conversely, one signal into n signals, with a low outlay on memory and expenditure of time.

This object is achieved by means of an nth stage multiplex apparatus 1 having a first multiplex apparatus stage 100 and a second multiplex apparatus stage 200, which can be connected via an interface 300, and with the second multiplex apparatus stage 200 comprising n/m mth stage multiplex devices 220.1, 220.2, . . ., 220.n/m. The first multiplex apparatus stage 100 has a first signal terminal 110 and the second multiplex apparatus stage 200 has n second signal terminals 210.1, 210.2, . . ., 210.n. This arrangement advantageously enables the second multiplex apparatus stage 200, through the n/m mth stage multiplex devices 220.1, 220.2, . . ., 220.n/m, to bring about a synchronized parallel processing of the n transmission-end signals (signal formation) or of the one reception-end signal (signal decomposition). The functional division of the signal creation between a plurality of mth stage multiplex devices 230.1, 230.2, . . ., 230.n/m allows a low-outlay realization of an nth stage signal formation in the SDH format or a signal decomposition into n signals.

Advantageous developments and designs of the nth stage multiplex apparatus according to the invention are described in patent claims 2 to 7. Claims 8 and 9 describe an associated method.

In an advantageous arrangement, the interface-side signal terminal 130 of the first multiplex apparatus stage stage 100 is connected to the n/m interface-side signal terminals 230.1, 230.2, . . ., 230.n/m of the second multiplex apparatus stage 200 via connection means 310. A bus system is preferably used as connection means. Use is made particularly preferably of a differential CML (Current Mode Logic) and especially preferably of a PCML (Positive Current Mode Logic) 16 bit bus.

In a preferred exemplary embodiment, the interface-side signal terminal 130 of the first multiplex apparatus stage 100 comprises n/m signal terminals 130.1, 130.n/m corresponding to the interface-side signal terminals 230.1, . . ., 230.n/m of the second multiplex apparatus stage 200. The connection between the n/m signal terminals 130.1, . . ., 130.n/m and the interface-side signal terminals 230.1, . . ., 230.n/m is effected by connection means 310, which may comprise individual connections between the individual terminals or alternatively a bus or a combination of both. In the case of signal decomposition, the connection means 310 especially preferably comprise a bus system which is routed via the interface-side signal terminal 130 of the first multiplex apparatus stage 100 past the interface-side signal terminals 230.1, . . ., 230.n/m of the second multiplex apparatus stage. In the case of signal formation, by contrast, the connection means especially preferably comprise individual connections between the n/m signal terminals 130.1, . . ., 130.n/m and the interface-side signal terminals 230.1, 230.n/m of the second multiplex apparatus stage 200.

This arrangement enables transmission-end signals or a reception-end signal to be processed in parallel by n/m mth stage multiplex devices 220.1, 220.2, . . ., 220.n/m. The n/m mth stage multiplex devices 220.1, 220.2, . . ., 220.n/m then require a smaller functional scope than an individual nth stage multiplex device; this enables faster processing of the individual signals. Moreover, such an arrangement enables a modular construction of an nth stage multiplex apparatus 1, which can be adapted exactly to the requirements of the user.

In a particularly preferred exemplary embodiment, the second signal terminals 210.1, 210.2, . . ., 210.n of the second multiplex apparatus stage 200 are arranged in such a way that the n signals are cyclically present at the n/m multiplex devices 220.1, 220.2, . . ., 220.n/m of the second multiplex apparatus stage 200. This has the advantage that the channels of the n/m subsignals are also present cyclically in a byte-sequential order at the interface-side terminals 230.1, 230.2, . . ., 230.n/m and can be processed, in particular fed into the first multiplex apparatus stage 100 via the connection means 310. The order of feeding the individual bytes of the channels of the n/m subsignals into the first multiplex apparatus stage 100 is prescribed by the cyclic arrangement of the n transmission-end signals at the n second signal terminals 210.1, 210.2, . . ., 210.n/m.

By way of example, a description is given of feeding the n/m subsignals at the interface-side terminals 230.1, 230.2, . . ., 230.n/m via the interface 300 to the first multiplex apparatus stage 100 given n=16 and m=4. In the case of these specifications, the second multiplex apparatus stage 200 comprises 4 m stage multiplex devices 220.1-220.4. The n signal terminals 210.1, 210.2, . . ., 210.n are bundled to the n/m mth stage multiplex devices 220.1, 220.2, . . ., 220.n/m in each case to form m terminals according to the following specification. The m input signals are applied to the zth mth stage multiplex device 220.z, so that the channel sequence of the zth subsignal satisfies the sequence z+(n/m)* i where i=0, 1, 2, . . . , ((n/m)−1) and z=1, . . ., n/m. According to this specification, each of the multiplex devices 220.1, . . . 220.4 of the second multiplex apparatus stage 200 processes 4 transmission-end signals and, on account of the processing of the now 16 transmission-end signals, 4 subsignals are present at the interface-side signal terminals 230.1-230.4. The subsignals then have the following channel sequence:

| | |
|---|---|
| Subsignal 1: | 1, 5, 9, 13 |
| Subsignal 2: | 2, 6, 10, 14 |
| Subsignal 3: | 3, 7, 11, 15 |
| Subsignal 4: | 4, 8, 12, 16 |

In an especially preferred arrangement, the n/m interface-side signal terminals 230.1, 230.2, . . ., 230.n/m of the multiplex apparatus stage 200 are an interface that is byte-parallel in the SDH format. In the case of a byte-parallel interface, the bytes of the n/m signals are transferred via the interface-side signal terminals 230.1, 230.2, . . ., 230.n/m of the multiplex apparatus stage 200 to the first multiplex apparatus stage 100 in such a way that the bytes are arranged in such a way that here already they satisfy the requirements demanded by the SDH format. It is especially advantageous in that case that the bytes are arranged by means of a low-outlay conversion by the converter 120 in the multiplex apparatus stage 100 into a byte sequence for the signal in the SDH format which no longer has to be re-sorted. Re-sorting is understood to mean the operation of converting a sequence of bytes that does not satisfy the SDH format into an arrangement of bytes that is demanded by the SDH format. In conventional methods, the sorting operation has required a high outlay on memory, needs time and generates a high power loss.

An illustration will be given by way of example of how the bytes are present at the byte-parallel interface in the SDH format. Proceeding from the above example, the byte channel tuples are arranged as follows.

Subsignal 1: 1.1, 1.5, 1.9, 1.13, 2.1, 2.5, . . .

Subsignal 2: 1.2, 1.6, 1.10, 1.14, 2.2, 2.6, . . .

Subsignal 3: 1.3, 1.7, 1.11, 1.15, 2.3, 2.7, . . .

Subsignal 4: 1.4, 1.8, 1.12, 1.16, 2.4, 2.8, . . .

where the first numeral specifies the byte of the byte channel tuple and the second numeral denotes the channel of the byte channel tuple.

The subsignals are present at the interface-side signal terminals 230.1, . . ., 230.4 in such a way that firstly the first byte channel tuple 1.1 of the subsignal 1 is present, then the second byte channel tuple 1.2 of the subsignal 2 is present, etc., until the byte channel tuple 1.16 of the subsignal 4 can then be fed in in order then to begin again with the byte channel tuple 2.1 of the first subsignal, until finally the byte channel tuple 8.16 of the subsignal 4 can be tapped off. As a result, it is possible to provide a signal with 16 channels which is already present after the second multiplex apparatus stage 200 with the correct byte and channel order in the SDH format at the interface-side signal terminals 230.1, . . ., 230.4. The byte channel tuple order reads, after conversion in the first multiplex apparatus stage 100, 1.1, 1.2, 1.3, 1.4, 1.5, 1.6, . . ., 1.16, 2.1, 2.2, 2.3, . . ., 8.15, 8.16. In order to be able to tap off a renewed signal at the interface-side signal terminals 230.1, 230.4, a beginning is again effected with the byte channel tuple 1.1 of the subsignal 1.

As a result of the composition of a signal according to the method just described, the signal comprising 16 channels already has the correct channel arrangement in order to be fed into the network. Re-sorting of the channels is no longer necessary. The first multiplex apparatus stage 100 only has the task of providing a suitable synchronization frame for the reception-end nth stage signal structure.

In an advantageous exemplary embodiment of the first multiplex apparatus stage 100, an opto-electrical transducer 150 and a converter 120 are provided. The opto-electrical transducer 150 has the task of converting optical signals into electrical signals or electrical signals into optical signals. Appropriate opto-electrical transducers 150 are particularly preferably PIN photodiode for short-haul systems and avalanche photodiodes for long-haul system.

By virtue of the arrangement of the opto-electrical transducer 150 centrally upstream of the second multiplex apparatus stage 200 and in the first multiplex apparatus stage 100, it is advantageously possible to convert the received optical signals into electrical signals by means of a central unit. Thus, the opto-electrical transducer 150 is pulled as it were centrally upstream of the system of the mth stage multiplex devices 220.1, 220.2, . . ., 220.n/m of the second multiplex apparatus stage 200. This avoids n/m opto-electrical conversions upstream of the n/m mth stage multiplex devices 220.1, 220.2, . . ., 220.n/m of the multiplex apparatus stage 200.

A particularly preferred embodiment is the arrangement of the converter 120 centrally in the first multiplex apparatus stage 100 analogously to the opto-electrical transducer 150. For reception-end signals, the converter 120 has the task of centrally bringing about a speed conversion of the input signal through parallel-serial conversion. The speed conversion is necessary in order to adapt the high-frequency bit rate on the line side to the maximum permissible processing frequency of the complex second multiplex apparatus stage 200, which is preferably realized using CMOS technology.

In this case it is expedient for outlay-optimizing reasons to provide a converter in the first multiplex apparatus stage 100 and not n/m converters in the second multiplex apparatus stages 200. Integrated circuits with Si-bipolar or GaAs technology are preferably used as converter 120.

For signals to be transmitted, the converter 120 has the task of producing a synchronous frame, for example an STM n frame from the n/m subsignals which have emerged from n/m multiplex devices 220.1, 220.2, . . ., 220.n/m. By virtue of the cyclic arrangement of the n signals in the transmission direction and the cyclic and sequential arrangement—thereby engendered—of the channels of the n/m subsignals at the interface-side signal terminals 230.1, 230.2, . . ., 230.n/m and the synchronized parallel processing of the n signals in the transmission direction in the second multiplex apparatus stage 200, provision of a TDM signal in the SDH format at the first terminal 110 of the first multiplex apparatus stage 100 by means of only one central converter 120 is possible. By virtue of the cyclic provision and the sequential tapping of the channels in the byte-parallel format at the interface-side signal terminals 230.1, 230.2, . . ., 230.n/m of the second multiplex apparatus stage 200, the channels for the signal in the SDH format are already arranged in the correct order after the second multiplex apparatus stage 200 and require only a simple byte multiplex function in the first multiplex apparatus stage. Said function is especially advantageously made possible by the only one central, parallel and serial high-speed converter stage 120. What is advantageous in this case is that this arrangement saves memory outlay in the buffer memory of the converter 120, because the channels of the n/m subsignals now need no longer be sorted in the converter 120 of the first multiplex apparatus stage 100.

Exemplary embodiments of the invention are explained in more detail with reference to figures.

In this case:

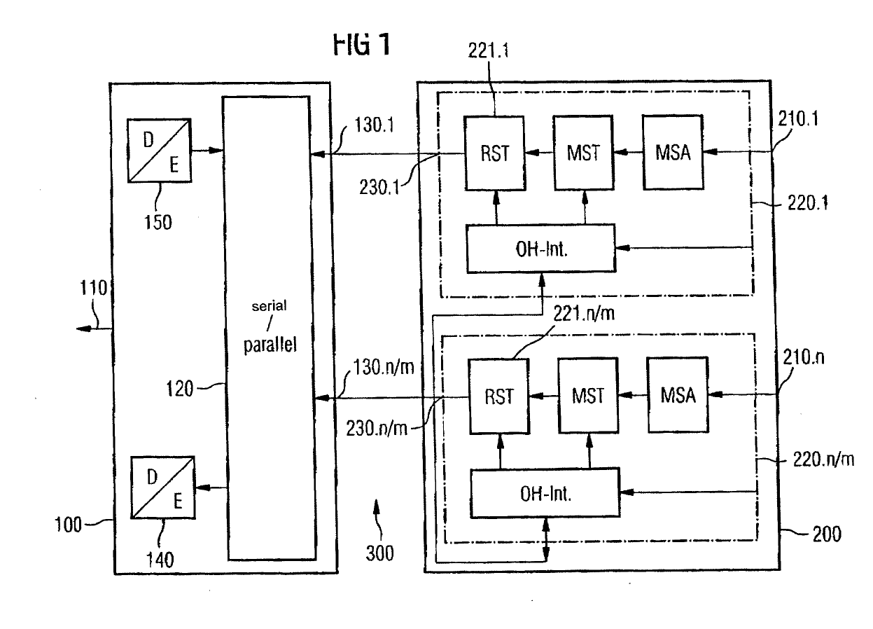

FIG. 1 shows a signal formation (transmission direction, TX) represented by a basic construction of an nth stage multiplex apparatus according to the invention;

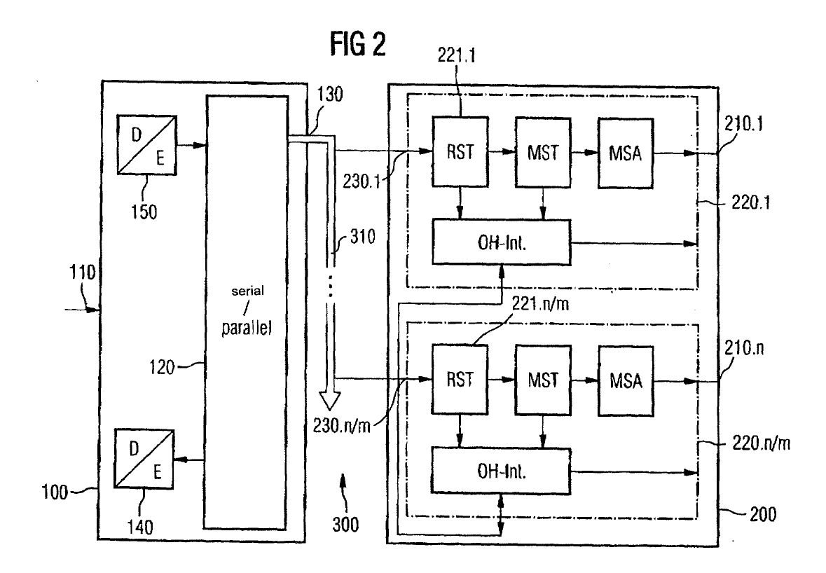

FIG. 2 shows a signal decomposition (reception direction, RX) represented by a basic construction of an nth stage multiplex apparatus according to the invention; and

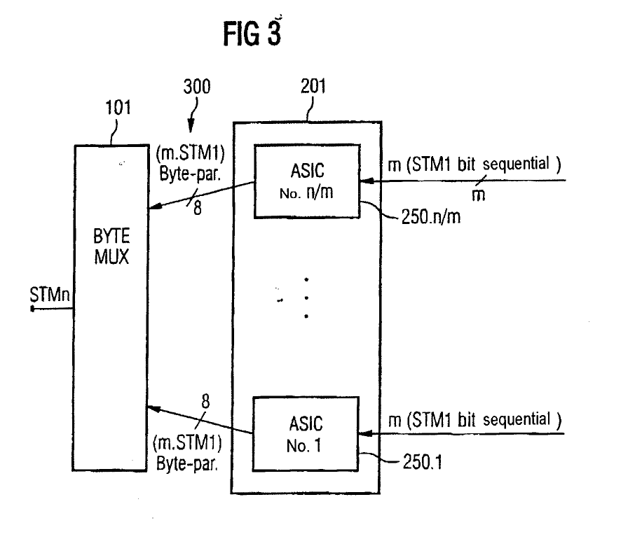

FIG. 3 shows a block diagram of an nth stage multiplex apparatus according to the invention for a signal formation.

FIG. 1 illustrates by way of example an nth stage multiplex apparatus for the transmission direction (TX) using two multiplex apparatus stages 100, 200. The multiplex apparatus stage 100 comprises a converter 120 and two opto-electrical transducers 140, 150. At the transmission end, the first multiplex apparatus stage 100 has a first signal terminal 110 and an interface-side signal terminal 130, which comprises n/m signal terminals 130.1, . . ., 130.n/m. In the case of the second multiplex apparatus stage 200, n/m mth stage multiplex devices 220.1, 220.2, . . ., 220.n/m are provided in parallel. The n/m mth stage multiplex devices 220.1, 220.2, . . ., 220.n/m each have at least one device for the allocation of a time window 221.1, 221.2, . . ., 221.n/m.

Arranged at the second multiplex apparatus stage 200 are the n second signal terminals 210.1, 210.2, . . ., 210.n and, on the interface side, the interface-side signal terminals 230.1, 230.2, . . ., 230.n/m. In this case, the n second signal terminals 210.1, 210.2, . . ., 210.n are distributed in such a way that a bundle of m terminals is in each case arranged at one of the n/m multiplex devices 220.1, 220.2, . . ., 220.n/m. In the interface 300, n/m signal terminals 130.1, . . ., 130.n/m of the first multiplex apparatus stage 100 correspond to the interface-side signal terminals 230.1, 230.2, . . ., 230.n/m of the second multiplex apparatus stage 200 via connection means 310.

If n transmission-end signals are applied to the n second signal terminals 210.1, 210.2, . . ., 210.n of the second multiplex apparatus stage 200, then the n transmission-end signals enter into the n/m mth stage multiplex devices 220.1, 220.2, . . ., 220.n/m, in each case m transmission-end signals being divided between the n/m mth stage multiplex devices 220.1, 220.2, . . ., 220.n/m. The m transmission-end signals of a multiplex device 220.z, z=1, . . ., n/m are multiplexed to form a zth subsignal, so that the n/m subsignals of the n/m mth stage multiplex devices 220.1, 220.2, . . ., 220.n/m are present at the n/m interface-side signal terminals 230.1, 230.2 . . ., 230.n/m. In the n/m multiplex devices 220.1, 220.2, . . ., 220.n/m, the n signals are processed in parallel to form n/m subsignals. The n second signal terminals 210.1, 210.2, . . ., 210.n are distributed cyclically between the n/m multiplex apparatuses in such a way that a cyclic sequential channel sequence is present at the interface-side signal terminals 230.1, 230.2, . . ., 230.n/m. The n/m subsignals are passed via the interface 300 to the converter 120 and to the opto-electrical transducer 140 of the first multiplex apparatus stage 100 until they emerge as an optical signal via the first signal terminal 110 of the first multiplex apparatus stage 100. In the parallel-serial converter 120, the n/m signals are processed to form a signal and provide it with a synchronized time frame, while the opto-electrical transducer 140 converts the electrical signals into optical signals. The byte-parallel arrangement of the channels of the n/m subsignals at the interface-side signal outputs 230.1, 230.2, . . ., 230.n/m of the multiplex apparatus stage 200 reduces the memory outlay in the multiplex apparatus stage 100 by a factor of 4. If we take up the above example again, then a buffer memory of 128 bits is conventionally required (4 multiplex devices 220.1, . . ., 220.4*4 transmission-end signals*8 bits=128 bit buffer memory), whereas the arrangement according to the invention only requires a buffer memory of 32 bits (4 multiplex devices 220.1, . . ., 220.4*8 bits=32 bit buffer memory).

Analogously to FIG. 1, FIG. 2 illustrates the construction of the nth stage multiplex apparatus 1 for the reception direction (RX). FIG. 2 shows, in contrast to FIG. 1, the decomposition of a signal which enters into the nth stage multiplex apparatus 1 at the reception end and is demultiplexed into n signals.

If a signal is applied to the first signal terminal 110 of the first multiplex apparatus stage 100, it is firstly converted into an electrical signal via an opto-electrical transducer 150, and is then brought via the converter 120, via the interface-side signal terminal 130 and via the connection means 310, i.e. a bus, to the interface-side signal terminals 230.1, 230.2, . . ., 230.n/m of the second multiplex apparatus stage 200. In this case, the entire electrical signal is present at each of the interface-side signal terminals 230.1, 230.2, . . ., 230.n/m. Via each of the interface-side signal terminals 230.1, 230.2, . . ., 230.n/m, the entire signal is brought to the complementary n/m mth stage multiplex devices 220.1, 220.2, . . ., 220.n/m with the interface-side signal terminals 230.1, 230.2, . . ., 230.n/m. The zth device for the allocation of a time window 221.z then taps off the zth subsignal for the zth multiplex device 220.z, z=1, . . ., n/m. The associated subsignal is in each case demultiplexed in each of the mth stage multiplex device 220.1, 220.2, . . ., 220.n/m. The respective m signals of the n/m mth stage multiplex devices 220.1, 220.2, . . ., 220.n/m are then communicated to the n second signal terminals 210.1, 210.2, . . ., 210.n of the second multiplex apparatus stage 200.

FIG. 3 illustrates a block diagram of a signal formation at an nth stage multiplex apparatus 1 according to the invention. In this case, the first multiplex apparatus stage 100 is represented as SDH multiplex stage 1101 and the second multiplex apparatus stage 200 as SDH multiplex stage 201 having n/m parallel ASICs 250.1, . . . 250.n/m.

An exemplary signal formation of n transmission-end signals into one signal is effected by the nth stage multiplex apparatus 1. For this purpose, the n transmission-end signals are bundled into in each case m signals and brought to the n/m Asics 250.1, . . . 250.n/m, which function as mth stage multiplex devices 220.1, . . ., 220.n/m. The n transmission-end signals bundled into in each case m signals are bit-sequential STM1 signals. The zth ASIC 250.z, z=1, . . ., n/m multiplexes the m STM1 bit-sequential signals into a zth subsignal. The zth subsignal is a byte-parallel STM1 signal. The multiplex operation for the zth subsignal is carried out in parallel for all n/m subsignals by the n/m Asics 250.1, . . ., 250.n/m. Since the channels of the n/m subsignals are present cyclically and sequentially at the interface 300, they can be subjected to parallel and serial conversion into a signal by the SDH multiplex stage I 101. At the same time a suitable synchronous timeframe is made available to the one signal, which frame fulfills the complex frame synchronization for the signal in the SDH format. An STM n signal is then available at the reception-end signal terminal 110.

1. An nth stage multiplex apparatus (1), comprising a first multiplex apparatus stage (100) and a second multiplex apparatus stage (200), which can be connected via an interface (300), and the first multiplex apparatus stage (100) has a first signal terminal (110) and the second multiplex apparatus stage (200) has n second signal terminals (210.1, 210.2, . . ., 210.n),
characterized in that
the second multiplex apparatus stage (200) comprises n/m mth stage multiplex devices (220.1, 220.2, . . ., 220.n/m).

2. The nth stage multiplex apparatus (1) as claimed in claim 1,
characterized in that
the first multiplex apparatus stage (100) comprises an interface-side signal terminal (130) and the second multiplex apparatus stage (200) comprises n/m interface-side signal terminals (230.1, 230.2, . . . 230.n/m) and connection means (310) connect the interface-side signal terminal (130) of the first multiplex apparatus stage (100) to the n/m interface-side signal terminals (230.1, 230.2, . . . 230.n/m) of the second multiplex apparatus stage (200).

3. The nth stage multiplex apparatus (1) as claimed in one of the preceding claims,
characterized in that
the interface-side signal terminal (130) of the first multiplex apparatus stage (100) comprises n/m individual signal terminals (130.1, . . ., 130.n/m) corresponding to the interface-side signal terminals (230.1, 230.2, . . . 230.n/m) of the second multiplex apparatus stage (200).

4. The nth stage multiplex apparatus (1) as claimed in one of the preceding claims,
characterized in that the n second signal terminals (210.1, 210.2, . . . 210.n) of the second multiplex apparatus stage (200) are arranged in such a way that n signals can be cyclically transferred to the n/m multiplex devices (220.1, 220.2, . . . 220.n/m) of the second multiplex apparatus stage (200).

5. The nth stage multiplex apparatus (1) as claimed in one of the preceding claims,
characterized in that
the n/m interface-side signal terminals (230.1, 230.2, . . ., 230.n/m) of the multiplex apparatus stage (200) constitute an interface that is byte-parallel in the SDH format.

6. The nth stage multiplex apparatus (1) as claimed in one of the preceding claims,
characterized in that
the first multiplex apparatus stage (100) has a converter (120) and an opto-electrical transducer (140, 150).

7. The nth stage multiplex apparatus (1) as claimed in one of the preceding claims,
characterized in that
the n/m mth stage multiplex stages (220.1, 220.2, . . ., 220.n/m) are designed as integrated circuits.

8. A method for transmitting a signal in an nth stage multiplex apparatus (1) as claimed in one of the preceding claims,
characterized in that
n transmission-end signals are multiplexed in the second multiplex apparatus stage (200) to form n/m subsignals and the n/m subsignals are combined via the interface (300) and the first multiplex apparatus stage (100) to form a signal, or
a reception-end signal are forwarded via the first multiplex apparatus stage (100) and the interface (300) to the n/m mth stage multiplex devices (220.1, 220.2, . . ., 220.n/m) and the mth stage multiplex devices (220.1, 220.2, . . ., 220.n/m) divide the signal into in each case m subsignals.

9. The method for transmitting a signal in an nth stage multiplex apparatus (1) as claimed in the preceding claim,
characterized in that
n transmission-end bit-sequential signals are processed in the second multiplex apparatus stage (200) to form n/m byte-parallel signals and these n/m byte-parallel signals are combined via the interface (300) and the first multiplex apparatus stage (100) to form a signal.
